(19) United States
(12) Patent Application Publication
(10) Pub. No.: US 2020/0313411 A1
(43) Pub. Date: Oct. 1, 2020

(54) Cable Stacker

(71) Applicant: NSi Industries, LLC, Huntersville, NC (US)

(72) Inventor: Mark Kent Williams, Spokane, WA (US)

(73) Assignee: NSi Industries, LLC, Huntersville, NC (US)

(21) Appl. No.: 16/813,397

(22) Filed: Mar. 9, 2020

Related U.S. Application Data
(60) Provisional application No. 62/824,231, filed on Mar. 26, 2019.

(51) Int. Cl. H02G 3/04; F16L 3/223

(52) U.S. Cl. CPC H02G 3/0456; F16L 3/2235

(57) ABSTRACT

In aspects of a cable stacker, the cable stacker includes a base for placement against a framing stud, and has dividers that extend perpendicular from the base. The dividers form cable slots between the dividers, and the cable slots accommodate cables that are guided in place between the dividers through open ends of the cable slots. The cable stacker can include cable separators that extend perpendicular from the dividers into the cable slots to separate the cables that are guided in place between the dividers. The cable stacker can also include cable retention tabs integrated with the dividers, where the cable retention tabs cover at least a portion of the open ends of the cable slots and retain the cables in the cable slots.

### RELATED APPLICATION

This application claims priority to U.S. Provisional Patent Application Ser. No. 62/824,231 filed Mar. 26, 2019 entitled “Cable Stacker”, the disclosure of which is incorporated by reference herein in its entirety.

### BACKGROUND

Wiring and any other types of cables are installed inside walls of a building during construction, and can be ran through conduit or other types of raceways that are anchored to the construction framing, or held in place by anchor devices that are applied every few feet to hold the wiring in place. Typically, the anchor devices can be attached to the construction framing, such as to wooden studs used in housing construction, or to metal studs used in commercial construction. Notably, construction compliance is mandated by the National Electric Code (NEC) 300-4-(d), which states that for both exposed and concealed locations, where a cable- or raceway-type wiring method is installed parallel to framing members, such as joists, rafters, or studs, or is installed parallel to furring strips, the cable or raceway shall be installed and supported so that the nearest outside surface of the cable or raceway is not less than 32 mm (1-¼ in.) from the nearest edge of the framing member or furring strips where nails or screws are likely to penetrate.

Generally, the anchor devices are UL listed products for safety and use certification, and are designed to keep the wiring and other types of cables from being damaged by screws or nails that are then used to install drywall or other building materials to the construction framing, enclosing the wiring inside the walls of the structure. However, typical anchor devices are flimsy and poorly made, as well as cumbersome to install. Given the very large number of anchor devices that are used throughout the construction industry, installation of wiring and other types of cables should be efficient with sturdy anchors for the installers that install and use the anchor devices.

### BRIEF DESCRIPTION OF THE DRAWINGS

Implementations of a cable stacker are described with reference to the following Figures. The same numbers may be used throughout to reference similar features and components that are shown in the Figures:

FIG. 1 illustrates features of an example cable stacker in accordance with aspects of the described anchor device.

FIG. 2 further illustrates views of the example cable stacker in accordance with aspects of the described anchor device.

FIG. 3 further illustrates features of the example cable stacker in accordance with aspects of the described anchor device, as well as an example of the cable stacker being utilized to guide and anchor cables in accordance with techniques for using the cable stacker.

FIG. 4 illustrates an example design in one implementation of the example cable stacker in accordance with aspects of the described anchor device.

FIG. 5 illustrates views and features of another example cable stacker in accordance with aspects of the described anchor device.

FIG. 6 further illustrates views and features of the example cable stacker in accordance with aspects of the described anchor device, as well as an example of the cable stacker being utilized to guide and anchor cables in accordance with techniques for using the cable stacker.

FIG. 7 illustrates an example method of a cable stacker in accordance with one or more implementations.

### DETAILED DESCRIPTION

Implementations of a cable stacker are described, and provide an anchor device that can be utilized to guide and anchor any types of wiring, cables, piping, and/or tubing (collectively referred to herein as “cables”), such as cables that are installed inside walls of a building during construction. Generally, cable stackers can be attached to construction framing every few feet, such as to wooden framing studs used in housing construction, or to metal framing studs used in commercial construction, to guide and protect the cables during construction. The design of the cable stacker is strong (e.g., not flimsy), and the cable stacker will hold in place during both installation and throughout application use of the cable stacker.

Notably, the cable stacker described herein has a base and dividers that extend perpendicular from the base of the cable stacker. The dividers form cable slots between the dividers and are designed to accommodate one or more cables that are guided in place between the dividers through open ends of the cable slots. This innovative design provides for a front-loading anchor device with the dividers that extend perpendicular from the base of the cable stacker, rather than the side-loading design of conventional anchor devices that are less stable, flimsy, and difficult to install.

The cable stacker described herein lends itself for use with a nail, one or two staples, and/or with one or two screws (e.g., #10 sheet metal screws or wood screws). Generally, one or two staples will stabilize the cable stacker in place, as will use of one or two screws, or a nail. Notably the cable stacker is designed to accommodate any one or all three forms of attachment using a nail, one or two staples, and/or one or two screws. Further, the design of the cable stacker allows for installation and subsequent mobility, such as to move the cable stacker to a different location or remove the cable stacker, which then remains in a reusable condition. Further, the cable stacker can be manufactured and shipped with a nail pre-installed, with the staples pre-installed, and/or with the screws pre-installed, depending on installation and application preference. This provides not only installer convenience, but allows for quick single-handed installation.

In aspects of the cable stacker described herein, the cable stacker has a base for placement against a framing stud, and the dividers extend perpendicular from the base. The dividers that extend from the base of the cable stacker form cable slots between the dividers, and the cable slots can accommodate one or more cables that are guided in place between the dividers through open ends of the cable slots. In an implementation, the dividers include a first divider, a second divider, and a center divider. Accordingly, a first cable slot is formed between the first divider and the center divider, and a second cable slot is formed between the second divider and the center divider. The cable stacker can include cable separators that extend from the dividers into the cable slots to separate the cables that are guided in place between the dividers. Each of the cable separators extend perpendicular from one of the dividers into one of the cable slots and is approximately horizontal to the base of the cable stacker. The cable separators are also removable to accommodate larger diameter cables being installed in the cable slots. Additionally, cable retention tabs can be integrated with the dividers, and the cable retention tabs cover at least a portion of the open ends of the cable slots to retain the cables in the cable slots. Alternatively or in addition, the cable stacker includes

The cable stacker can also include an integrated nail guide to facilitate attachment of the cable stacker to the framing stud with a nail, and the integrated nail guide is designed to retain the nail in an installation position. Alternatively or in addition, the cable stacker can include an integrated staple guide to facilitate attachment of the cable stacker to the framing stud with a staple, and the integrated staple guide is designed to retain the staple in an installation position. Alternatively or in addition, the cable stacker can also include an integrated screw guide to facilitate attachment of the cable stacker to the framing stud with a screw, and the integrated screw guide is designed to retain the screw in an installation position.

While features and concepts of a cable stacker can be implemented in any number of different devices, systems, environments, and/or configurations, implementations of a cable stacker are described in the context of the following example devices, systems, and methods.

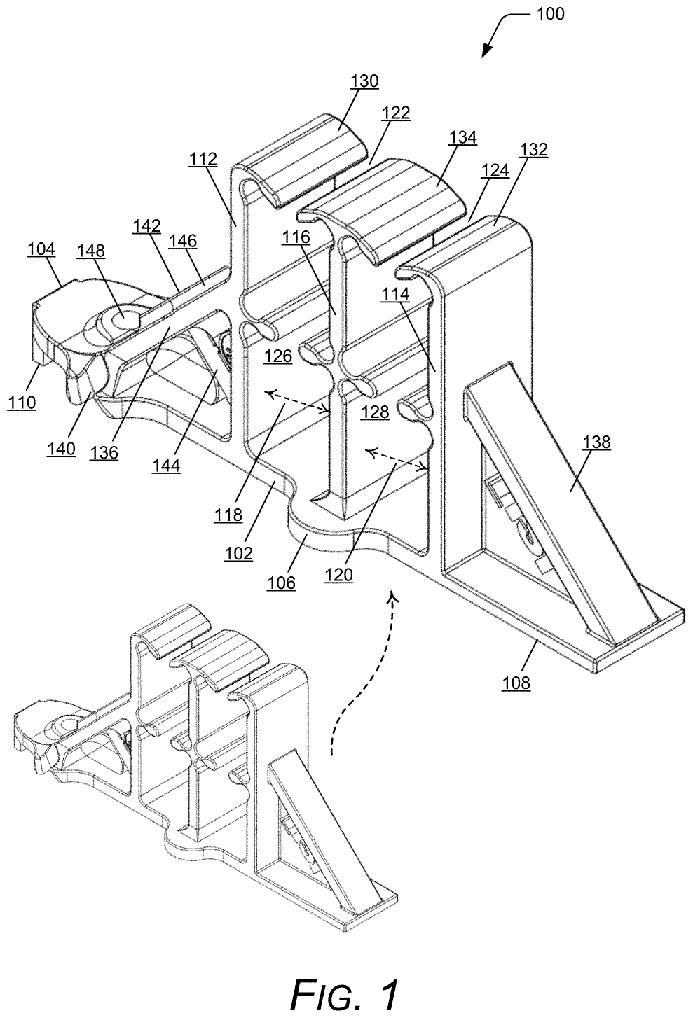

FIG. 1 illustrates features of an example cable stacker 100 in accordance with aspects of the described anchor device. The cable stacker 100 is an anchor device that can be utilized to guide and anchor wiring and any other types of cables (collectively referred to herein as “cables”), such as cables that are installed inside walls of a building during construction. Generally, cable stackers can be attached to construction framing every few feet, such as to wooden framing studs used in housing construction, or to metal framing studs used in commercial construction, to guide and protect the cables during construction.

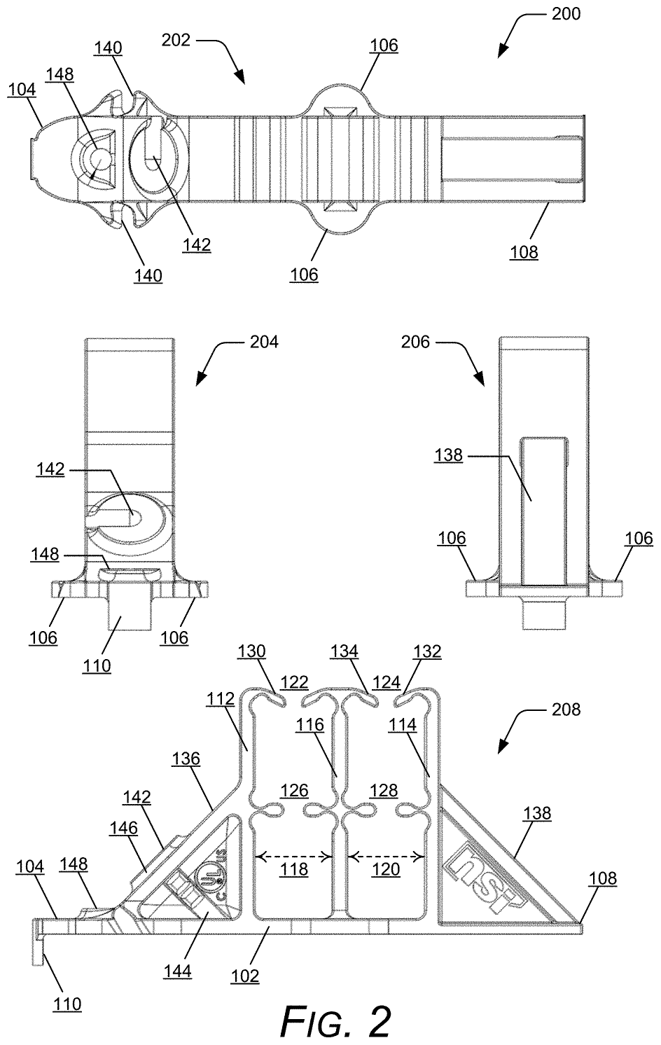

The cable stacker 100 has a base 102 designed for placement against a framing stud (e.g., a wooden stud, a metal stud, or other framing material). The base 102 of the cable stacker has a first end 104 and integrated stabilizers 106 that provide stability and are generally designed to prevent transverse rotation of the cable stacker 100 while the base 102 is placed against a framing stud. Similarly, the base 102 of the cable stacker has a second end 108. In this example, the base 102 of the cable stacker 100 also includes an alignment stop 110 that is designed to abut against a framing stud for ease of alignment and installation when the base 102 of the cable stacker is placed against the framing stud. This is further shown and described with reference to FIGS. 2-4 in which several different views of the cable stacker 100 are shown.

As described herein, various components or pieces of the cable stacker are integrated with the base 102, and/or integrated with each other, where “integrated” indicates that the cable stacker 100 is manufactured as a “one-piece” molded plastic device. For example, the cable stacker 100 may be manufactured using a polypropylene molded plastic, or can be manufactured using various other types of materials. Alternatively, any of the components or pieces of the cable stacker described herein may be manufactured separately and attached or connected by any number of various means.

The cable stacker 100 includes dividers that extend perpendicular from the base 102. In this example, the cable stacker 100 has a first divider 112, a second divider 114, and a center divider 116 that are each integrated on one end with the base 102 and extend perpendicular from the base. The dividers form cable slots between the dividers. For example, a first cable slot 118 is formed between the first divider 112 and the center divider 116, and similarly, a second cable slot 120 is formed between the second divider 114 and the center divider 116. Although the cable stacker 100 is shown and described with the three dividers that extend perpendicular from the base 102 in this example, a cable stacker may be implemented with only two dividers that form one cable slot between the dividers, or may be implemented with more than three dividers forming additional cable slots to accommodate a larger number of cables, wiring, piping, tubing, etc.

The cable slots 118, 120 are designed to accommodate one or more cables that are guided in place between the dividers through open ends of the cable slots. For example, the cable slot 118 is bounded on three sides by the first divider 112, the base 102, and the center divider 116. The open end 122 of the cable slot 118 is then the end in which one or more cables can be installed between the first divider 112 and the center divider 116. Similarly, the cable slot 120 is bounded on three sides by the second divider 114, the base 102, and the center divider 116. The open end 124 of the cable slot 120 is then the end in which one or more cables can be installed between the second divider 114 and the center divider 116.

In implementations, the cable slots 118, 120 may include respective cable separators 126, 128 that extend from the dividers into the cable slots to separate the cables that are guided in place between the dividers. The cable separators 126, 128 are designed to be multi-directional, effective to facilitate cables being installed in the cable slots 118, 120 and subsequently being taken out of the cable slots. For example, the cable slot 118 has the cable separators 126 that are integrated on one end and extend from the first divider 112 and the center divider 116, generally horizontal with the base 102 of the cable stacker and perpendicular from the dividers. The cable separators 126 are flexibly integrated (or flexibly attached, flexibly connected) with the first divider 112 and the center divider 116, allowing the cable separators 126 to pivot at the point of flexible attachment or integration with the first divider 112 and the center divider 116, and providing that cables can be installed and removed from the cable slot 118.

Similarly, the cable slot 120 has the cable separators 128 that are integrated on one end and extend from the second divider 114 and the center divider 116, generally horizontal with the base 102 of the cable stacker and perpendicular from the dividers. The cable separators 128 are flexibly integrated (or flexibly attached, flexibly connected) with the second divider 114 and the center divider 116, allowing the cable separators 128 to pivot at the point of flexible attachment or integration with the second divider 114 and the center divider 116, and providing that cables can be installed and removed from the cable slot 120.

Notably, the cable separators 126, 128 that extend from the respective dividers into the cable slots 118, 120 are removable to accommodate larger diameter cables. For example, an electrician or other installer may simply snip out any of the cable separators 126, 128 with a pliers, providing easier installation of larger diameter cables and wiring, such as for larger, commercial and/or industrial cables. Alternatively, an implementation of the cable stacker 100 may be manufactured without the cable separators in the cable slots.

The cable stacker 100 also includes cable retention tabs that are effective to prevent cables that are installed into the cable slots from falling out of the cable slots. For example, a cable retention tab 130 is integrated on one end with the first divider 112 and is designed to cover a portion of the cable slot 118 at the open end 122 of the cable slot. The cable retention tab 130 is flexibly integrated (or flexibly attached, flexibly connected) with the first divider 112, allowing the retention tab 130 to pivot at the point of flexible attachment or integration with the first divider, and providing that cables can be installed and removed from the cable slot 118. Similarly, a cable retention tab 132 is integrated on one end with the second divider 114 and is designed to cover a portion of the cable slot 120 at the open end 124 of the cable slot. The cable retention tab 132 is flexibly integrated (or flexibly attached, flexibly connected) with the second divider 114, allowing the retention tab 132 to pivot at the point of flexible attachment or integration with the second divider, and providing that cables can be installed and removed from the cable slot 120.

The center divider 116 also includes integrated cable retention tabs 134 that are designed to cover a portion of both the cable slots 118, 120 at the respective open ends 122, 124 of the cable slots. A first part of the retention tab 134 is flexibly integrated (or flexibly attached, flexibly connected) with the center divider 116 approximately opposite from the retention tab 130 that is integrated with the first divider 112. Together, the retention tabs 130, 134 pivotably flex providing that cables can be installed and removed from the cable slot 118, while also forming a barrier at the open end 122 of the cable slot effective to prevent installed cables from falling out of the cable slot. Similarly, a second part of the retention tab 134 is flexibly integrated (or flexibly attached, flexibly connected) with the center divider 116 approximately opposite from the retention tab 132 that is integrated with the second divider 114. Together, the retention tabs 132, 134 pivotably flex providing that cables can be installed and removed from the cable slot 120, while also forming a barrier at the open end 124 of the cable slot effective to prevent installed cables from falling out of the cable slot.

In this example, the cable stacker 100 includes angle supports that are integrated with the base 102 and with the first and second dividers 112, 114 effective to strengthen the anchor device. For example, a first angle support 136 is integrated with the base 102 and the first divider 112 effective to strengthen the structure of the cable stacker, generally at the first end 104 of the cable stacker. Similarly, a second angle support 138 is integrated with the base 102 and the second divider 114 effective to strengthen the structure of the cable stacker, generally at the second end 108 of the cable stacker.

The example cable stacker 100 also includes integrated staple guides to facilitate attachment of the cable stacker to a framing stud (e.g., a wooden stud) with a staple. For example, an integrated staple guide 140 of the cable stacker 100 is designed to keep a staple aligned for installation and retain the staple in an installation position at the first end 104 of the cable stacker. Further, a staple can be retained in the installation position in any attachment configuration of the cable stacker, such as when inverted. Notably, the integrated staple guide 140 that is viewable on the one side of the cable stacker 100 in the illustration is similar in design to the integrated staple guide that is not viewable on the opposite side of the cable stacker. In implementations, the integrated staple guide 140 can also function as a stabilizer, such as the integrated stabilizers 106 that provide stability and are generally designed to prevent transverse rotation of the cable stacker 100 while placed against a framing stud. In this example, the staple guide 140 is integrated proximate the first end 104 of the cable stacker 100. Alternatively or in addition, the cable stacker 100 may include similar staple guides integrated in the second end 108 of the cable stacker.

The example cable stacker 100 also includes an integrated nail guide 142 with a nail cavity 144 to facilitate attachment of the cable stacker to a framing stud (e.g., a wooden framing stud) with a nail. The integrated nail guide 142 is designed to retain a nail in an installation position for quick attachment of the cable stacker to the framing stud, and the nail can be retained in the installation position in any attachment configuration of the cable stacker, such as when inverted. Further, in this example implementation, the integrated nail guide 142 also includes a reinforced hammer strike area 146. In this example, the nail guide 142 is integrated proximate the first end 104 of the cable stacker 100. Alternatively or in addition, the cable stacker 100 may include a similar nail guide integrated in the second end 108 of the cable stacker.

The example cable stacker 100 also includes an integrated screw guide to facilitate attachment of the cable stacker to a framing stud (e.g., a metal framing stud) with a screw. For example, an integrated screw guide 148 of the cable stacker 100 retains a screw in an installation position at the first end 104 of the cable stacker, and the screw can be retained in the installation position in any attachment configuration of the cable stacker, such as when inverted. The screw guide may also be reinforced to facilitate a screw going in straight and perpendicular to the base 102, rather than getting installed at an off-angle. In this example, the screw guide 148 is integrated proximate the first end 104 of the cable stacker 100. Alternatively or in addition, the cable stacker 100 may include a similar screw guide integrated in the second end 108 of the cable stacker.

FIG. 2 further illustrates several different views 200 of the example cable stacker 100 in accordance with aspects of the described anchor device as shown and described with reference to FIG. 1. The different views 200 include a top view 202 of the cable stacker, an end view 204 of the first end 104 of the cable stacker, an end view 206 of the second end 108 of the cable stacker, as well as a side view 208 of the cable stacker. The various features and aspects of the cable stacker 100 are identified in the different views as also shown and described with reference to FIG. 1.

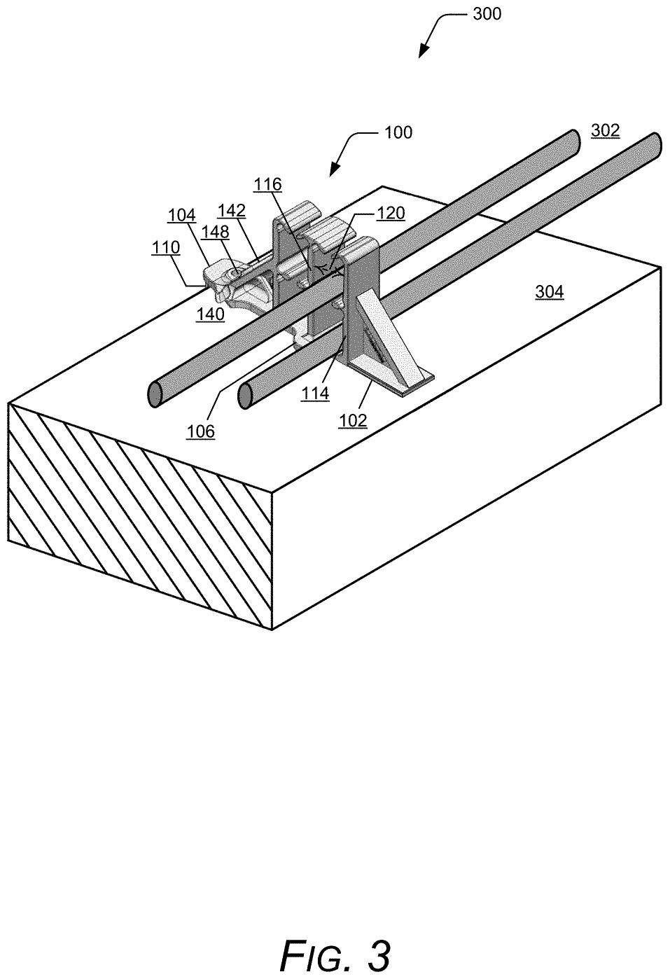

FIG. 3 further illustrates features of the example cable stacker 100 in accordance with aspects of the described anchor device, as well as an example 300 of the cable stacker 100 being utilized to guide and anchor cables 302 for cable installation in accordance with techniques for using the anchor device. As noted above, the cable stacker 100 can be attached to construction framing every few feet, such as to a wooden framing stud 304 used in housing construction, or to a metal framing stud used in commercial construction, to guide and protect the cables 302 during construction. The base 102 of the cable stacker 100 is designed for placement against the framing stud 304, and the integrated stabilizers 106 provide stability and are generally designed to prevent transverse rotation of the cable stacker 100 while the base 102 is placed against the framing stud.

The base 102 of the cable stacker 100 includes the alignment stop 110 (not viewable behind the framing stud) at the first end 104 of the cable stacker, and the alignment stop 110 is designed to abut against the framing stud for ease of alignment and installation when the base 102 of the cable stacker is placed against the framing stud. In this example 300, the cables 302 are shown installed (e.g., guided and anchored) in the cable slot 120 that is formed between the second divider 114 and the center divider 116. The cable stacker 100 can be anchored to the framing stud 304 utilizing any one or combination of a staple installed in the staple guides 140, a nail installed in the nail guide 142, and/or a screw installed in the screw guide 148.

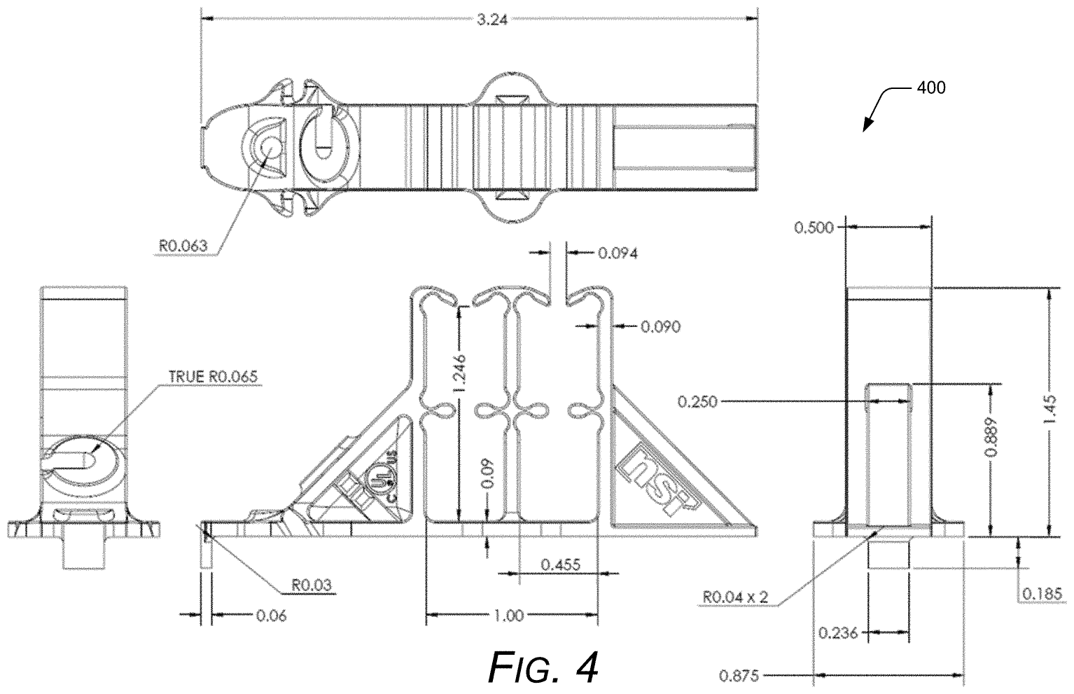

FIG. 4 illustrates an example design 400 in one implementation of the example cable stacker 100 in accordance with aspects of the described anchor device, such as shown and described with reference to FIGS. 1-3. Example dimensions of the various components of the cable stacker 100 are shown to illustrate one example implementation of the cable stacker. In alternate implementations, any one or more of the various components of the cable stacker 100 may be of a different size and/or reconfigured.

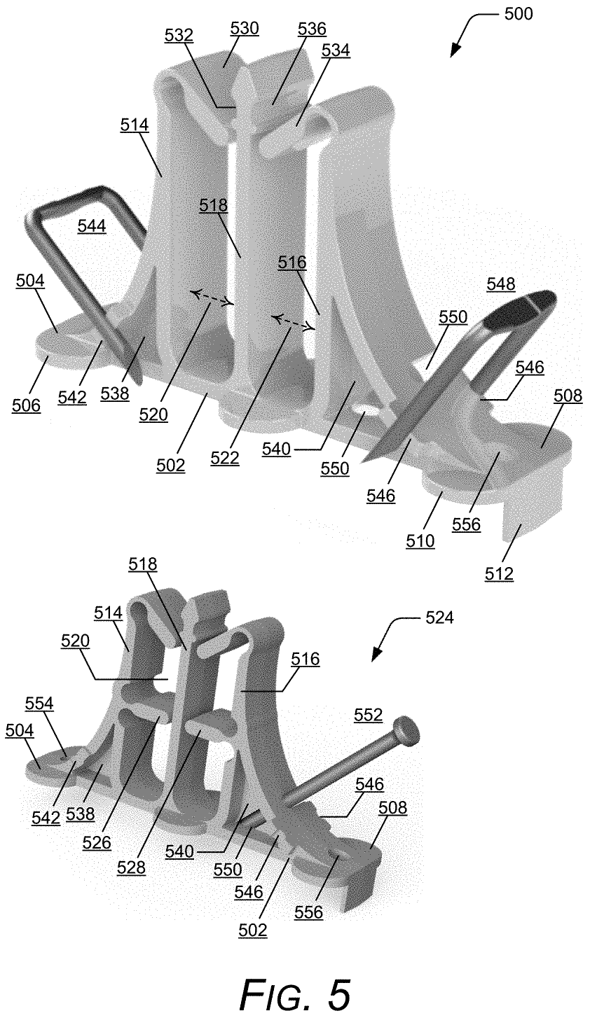

FIG. 5 illustrates views and features of another example cable stacker 500 in accordance with aspects of the described anchor device. The cable stacker 500 is an anchor device that can be utilized to guide and anchor wiring and any other types of cables, wiring, piping, tubing, etc. (collectively referred to herein as “cables”), such as cables that are installed inside walls of a building during construction. Generally, cable stackers can be attached to construction framing every few feet, such as to wooden framing studs used in housing construction, or to metal framing studs used in commercial construction, to guide and protect the cables during construction.

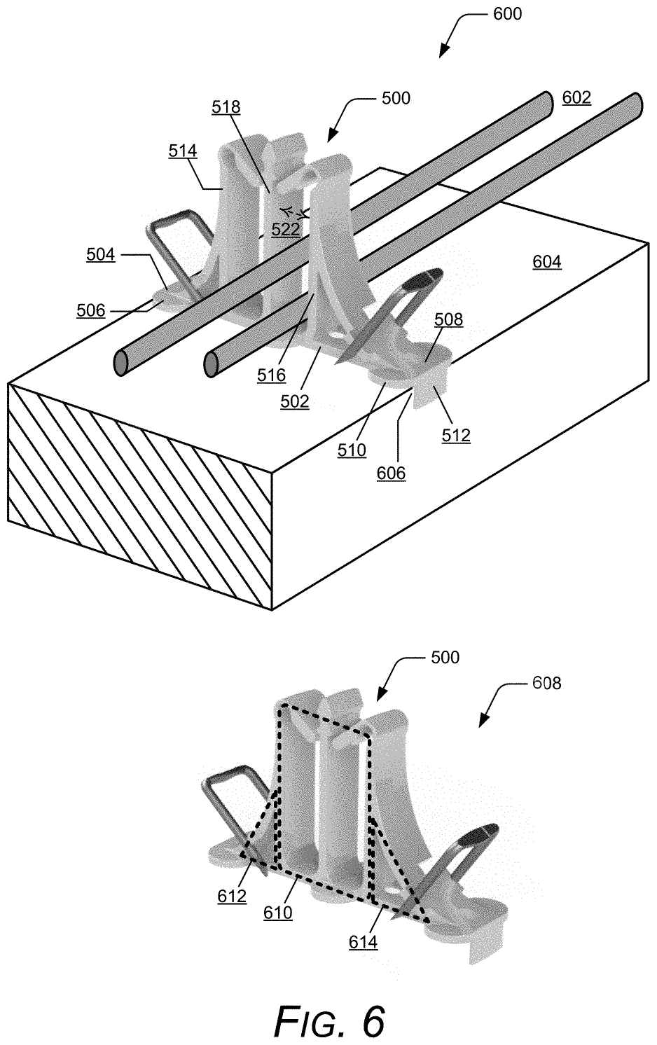

The cable stacker 500 has a base 502 designed for placement against a framing stud (e.g., a wooden stud, a metal stud, or other framing material). The base 502 of the cable stacker has a first end 504 with integrated stabilizers 506 that provide stability and are generally designed to prevent transverse rotation of the cable stacker 500 while the base 502 is placed against a framing stud. Similarly, the base 502 of the cable stacker has a second end 508 with integrated stabilizers 510. In this example, the base 502 of the cable stacker 500 also includes an alignment stop 512 that is designed to abut against a framing stud for ease of alignment and installation when the base 502 of the cable stacker is placed against the framing stud. This is further shown and described with reference to FIG. 6.

As described herein, various components or pieces of the cable stacker are integrated with the base 502, and/or integrated with each other, where “integrated” indicates that the cable stacker is manufactured as a “one-piece” molded plastic device. For example, the cable stacker 500 may be manufactured using a polypropylene molded plastic, or can be manufactured using various other types of materials. Alternatively, any of the components or pieces of the cable stacker described herein may be manufactured separately and attached or connected by any number of various means.

The cable stacker 500 includes dividers that extend perpendicular from the base 502. In this example, the cable stacker 500 has a first divider 514, a second divider 516, and a center divider 518 that are each integrated on one end with the base 502 and extend perpendicular from the base. The dividers form cable slots between the dividers. For example, a first cable slot 520 is formed between the first divider 514 and the center divider 518, and similarly, a second cable slot 522 is formed between the second divider 516 and the center divider 518. Although the cable stacker 500 is shown and described with the three dividers that extend perpendicular from the base 502 in this example, a cable stacker may be implemented with only two dividers that form one cable slot between the dividers, or may be implemented with more than three dividers forming additional cable slots to accommodate a larger number of cables, wiring, piping, tubing, etc.

The cable slots 520, 522 are designed to accommodate one or more cables that are guided in place between the dividers through open ends of the cable slots. For example, the cable slot 520 is bounded on three sides by the first divider 514, the base 502, and the center divider 518. The open end of the cable slot 520 is then the end in which one or more cables can be installed between the first divider 514 and the center divider 518. Similarly, the cable slot 522 is bounded on three sides by the second divider 156, the base 502, and the center divider 518. The open end of the cable slot 522 is then the end in which one or more cables can be installed between the second divider 516 and the center divider 518.

An additional view 524 of the cable stacker 500 is shown in the illustration, with many of the same identifiers indicating the components of the cable stacker as discussed above and in more detail below. As shown in the additional view 524, the cable slots 520, 522 may include cable separators 526, 528 that extend from the dividers into the cable slots to separate the cables that are guided in place between the dividers. For example, the cable slot 520 has the cable separator 526 that is integrated on one end and extends from the first divider 514, generally horizontal with the base 502 of the cable stacker and perpendicular from the divider. The cable separator 526 is flexibly integrated (or flexibly attached, flexibly connected) with the first divider 514, allowing the cable separator 526 to pivot at the point of flexible attachment or integration with the first divider 514, and providing that cables can be installed and removed from the cable slot 520.

Similarly, the cable slot 522 has the cable separator 528 that is integrated on one end and extends from the second divider 516, generally horizontal with the base 502 of the cable stacker and perpendicular from the divider. The cable separator 528 is flexibly integrated (or flexibly attached, flexibly connected) with the second divider 516, allowing the cable separator 528 to pivot at the point of flexible attachment or integration with the second divider 516, and providing that cables can be installed and removed from the cable slot 522.

Notably, the cable separators 526, 528 that extend from the respective dividers into the cable slots 520, 522 are removable to accommodate larger diameter cables. For example, an electrician or other installer may simply snip out one or both of the cable separators 526, 528 with a pliers, providing easier installation of larger diameter cables and wiring, such as for larger, commercial and/or industrial cables. As shown in the illustration of the cable stacker 500 at the top of the figure, the cable slots 520, 522 do not include the cable separators 526, 528 to illustrate that the cable separators can be removed. Alternatively, an implementation of the cable stacker 500 may be manufactured without the cable separators in the cable slots.

The cable stacker 500 also includes retention locks that close the open ends of the cable slots, providing to secure the cables that are installed into the cable slots. For example, a retention lock 530 is integrated on one end with the first divider 514 and is designed to engage a detent 532 in the center divider 518 to close the open end of the cable slot 520 that is formed between the first divider 514 and the center divider 518. The retention lock 530 is flexibly integrated (or flexibly attached, flexibly connected) with the first divider 514, allowing the retention lock 530 to pivot at the point of flexible attachment or integration with the first divider, and providing that cables can be installed and removed from the cable slot 520. Similarly, a retention lock 534 is integrated on one end with the second divider 516 and is designed to engage a detent 536 in the center divider 518 to close the open end of the cable slot 522 that is formed between the second divider 516 and the center divider 518. The retention lock 534 is flexibly integrated (or flexibly attached, flexibly connected) with the second divider 516, allowing the retention lock 534 to pivot at the point of flexible attachment or integration with the second divider, and providing that cables can be installed and removed from the cable slot 522.

In this example cable stacker 500, the base 502, the first and second dividers 514, 516, and the retention locks 530, 534 form a rigid structural box around the cables that would be guided in place in the cable slots 520, 522 between the dividers. In this example, the cable stacker 500 also includes angle supports that are integrated with the base 502 and with the first and second dividers 514, 516 effective to strengthen the rigid structural box that is formed by the base, the dividers, and the retention locks. For example, a first angle support 538 is integrated with the base 502 and the first divider 514 effective to strengthen the structure of the cable stacker, generally at the first end 504 of the cable stacker. Similarly, a second angle support 540 is integrated with the base 502 and the second divider 516 effective to strengthen the structure of the cable stacker, generally at the second end 508 of the cable stacker. The design features of the incorporated rigid structural box and angle supports to strengthen the overall structure of the cable stacker 500 are further shown and described with reference to FIG. 6.

The example cable stacker 500 includes integrated staple guides to facilitate attachment of the cable stacker to a framing stud (e.g., a wooden stud) with one or two staples. For example, an integrated staple guide 542 of the cable stacker 500 retains a staple 544 in an installation position at the first end 504 of the cable stacker, and the staple 544 is retained in the installation position in any attachment configuration of the cable stacker, such as when inverted. Notably, the integrated staple guide 542 that is viewable on the one side of the cable stacker in the illustration is similar in design to the integrated staple guide that is not viewable on the opposite side of the cable stacker in the illustration. Similarly, an integrated staple guide 546 of the cable stacker 500 retains a staple 548 in an installation position at the second end 508 of the cable stacker. The integrated staple guides 542, 546 are shown in both the illustration of the cable stacker 500 at the top of the figure with the staples 544, 548 retained in the installation position, and in the additional view 524 without the staples. Further, as can be seen in the illustration, the protrusion ends of the staples 544, 548 are accessible while a staple is retained in the installation position to accommodate easily removing a staple from the cable stacker. The cable stacker 500 may be packaged and shipped with or without the staples pre-installed in the integrated staple guides 542, 546.

The example cable stacker 500 also includes an integrated nail guide 550 to facilitate attachment of the cable stacker to a framing stud (e.g., a wooden framing stud) with a nail 552. The integrated nail guide 550 is designed to retain the nail 552 in an installation position for quick attachment of the cable stacker to the framing stud, and the nail 552 is retained in the installation position in any attachment configuration of the cable stacker, such as when inverted. The integrated nail guide 550 is shown in both the additional view 524 with the nail 552 retained in the installation position, and in the illustration of the cable stacker 500 at the top of the figure without the nail. The cable stacker 500 may be packaged and shipped with or without a nail pre-installed in the integrated nail guide 550.

The example cable stacker 500 also includes integrated screw guides to facilitate attachment of the cable stacker to a framing stud (e.g., a metal framing stud) with screws at one or both ends of the cable stacker. For example, an integrated screw guide 554 of the cable stacker 500 (shown in the additional view 524) retains a screw (not shown) in an installation position at the first end 504 of the cable stacker, and the screw is retained in the installation position in any attachment configuration of the cable stacker, such as when inverted. Similarly, an integrated screw guide 556 of the cable stacker 500 retains a screw (not shown) in an installation position at the second end 508 of the cable stacker. As above, the cable stacker 500 may be packaged and shipped with or without a screw pre-installed in one or both of the integrated screw guides 554, 556.

FIG. 6 further illustrates views and features of the example cable stacker 500 in accordance with aspects of the described anchor device, as well as an example 600 of the cable stacker 500 being utilized to guide and anchor cables 602 for cable installation in accordance with techniques for using the anchor device. As noted above, the cable stacker 500 can be attached to construction framing every few feet, such as to a wooden framing stud 604 used in housing construction, or to a metal framing stud used in commercial construction, to guide and protect the cables 602 during construction. The base 502 of the cable stacker 500 is designed for placement against the framing stud 604, and the integrated stabilizers 506 (at the first end 504 of the cable stacker), along with the integrated stabilizers 510 (at the second end 508 of the cable stacker), provide stability and are generally designed to prevent transverse rotation of the cable stacker 500 while placed against a framing stud.

The base 502 of the cable stacker 500 includes the alignment stop 512 that is designed to abut against the framing stud as shown at 606 for ease of alignment and installation when the base 502 of the cable stacker is placed against the framing stud. In this example 600, the cables 602 are shown installed (e.g., guided and anchored) in the cable slot 522 that is formed between the second divider 516 and the center divider 518. The cable stacker 500 can be anchored to the framing stud 604 utilizing any one or combination of staples installed in the staple guides 542, 546, a nail installed in the nail guide 550, and/or screws installed in the screw guides 554, 556.

An additional view 608 of the cable stacker 500 is shown in the figure to illustrate the rigid structural box 610 that is formed around the cables which are guided in place in the cable slots between the dividers of the cable stacker. As noted above, the base 502, the first and second dividers 514, 516, and the retention locks 530, 534 form the rigid structural box 610 (i.e. , when the retention locks 530, 534 are engaged in the respective detents 532, 536 in the center divider 518). Further, the first angle support 538 of the cable stacker 500 is integrated with the base 502 and the first divider 514 effective to strengthen the structure 612 of the cable stacker. Similarly, the second angle support 540 of the cable stacker 500 is integrated with the base 502 and the second divider 516 effective to strengthen the structure 614 of the cable stacker. The design features of the incorporated rigid structural box 610 and the angle support structures 612, 614 strengthen the overall structure of the cable stacker.

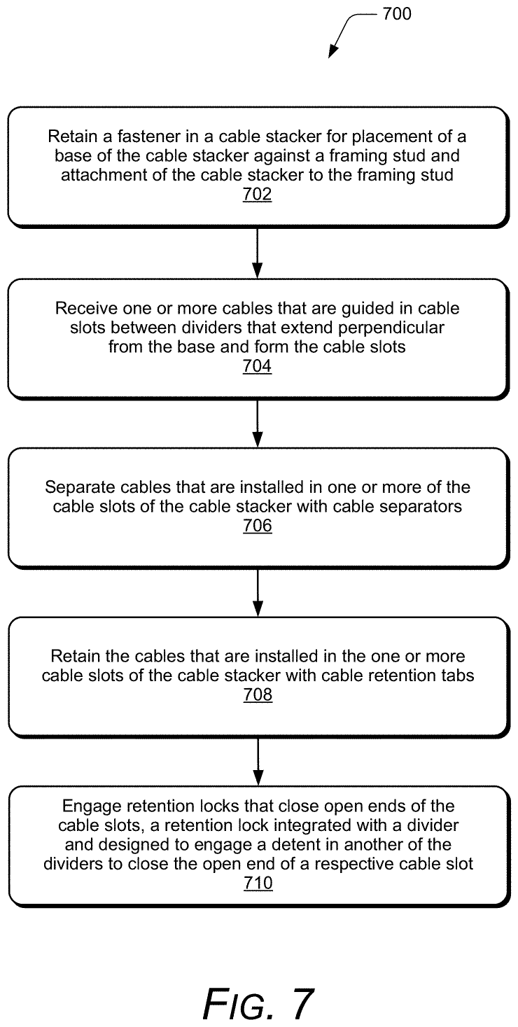

FIG. 7 illustrates an example method 700 for implementations of a cable stacker as shown and described with reference to FIGS. 1-6. The order in which the method is described is not intended to be construed as a limitation, and any number or combination of the method operations can be combined in any order to implement a method, or an alternate method.

At 702, a fastener is retained in a cable stacker for placement of a base of the cable stacker against a framing stud and attachment of the cable stacker to the framing stud. In implementations, the fastener may be any one or combination of a nail, staples, and/or screws that facilitate attachment of the cable stacker 100 to a framing stud (e.g., wood, metal, or other type of material). The fastener may be a nail retained in an installation position with an integrated nail guide 144 of the cable stacker to facilitate the attachment of the cable stacker to the framing stud with the nail. The fastener may be at least one staple retained in an installation position with an integrated staple guide 140 of the cable stacker to facilitate the attachment of the cable stacker to the framing stud with the at least one staple. The fastener may be at least one screw retained in an installation position with an integrated screw guide 148 of the cable stacker to facilitate the attachment of the cable stacker to the framing stud with the at least one screw.

At 704, one or more cables are received that are guided in cable slots between dividers that extend perpendicular from the base and form the cable slots. For example, the cable stacker 100 includes the dividers that extend perpendicular from the base 102, such as the first divider 112, the second divider 114, and the center divider 116 that are each integrated on one end with the base 102 and extend perpendicular from the base. The dividers form the cable slots between the dividers, such as the first cable slot 118 that is formed between the first divider 112 and the center divider 116, and similarly, the second cable slot 120 that is formed between the second divider 114 and the center divider 116. The cable slots 118, 120 can receive one or more cables that are guided in place between the dividers through the open ends of the cable slots. For example, the cable slot 118 is bounded on three sides by the first divider 112, the base 102, and the center divider 116. The open end 122 of the cable slot 118 is then the end that receives one or more cables installed between the first divider 112 and the center divider 116. Similarly, the cable slot 120 is bounded on three sides by the second divider 114, the base 102, and the center divider 116. The open end 124 of the cable slot 120 is then the end that receives one or more cables installed between the second divider 114 and the center divider 116.

At 706, the cables installed in one or more of the cable slots of the cable stacker are separated by cable separators. For example, the cable slots 118, 120 of the cable stacker 100 include respective cable separators 126, 128 that extend from the dividers into the cable slots to separate the cables that are guided in place between the dividers. The cable separators 126, 128 are integrated on one end and extend from the dividers, generally horizontal with the base 102 of the cable stacker and perpendicular from the dividers. The cable separators 126, 128 are flexibly integrated (or flexibly attached, flexibly connected) with the dividers, allowing the cable separators to pivot at the point of flexible attachment or integration with the dividers, providing that cables can be installed and removed from the cable slots.

At 708, the cables installed in one or more of the cable slots of the cable stacker are retained in the cable slots by cable retention tabs. For example, the cable retention tabs 130, 132, 134 of the cable stacker 100 are effective to prevent cables that are installed into the cable slots 118, 120 from falling out of the cable slots. The cable retention tab 130 is integrated on one end with the first divider 112 and covers a portion of the cable slot 118 at the open end 122 of the cable slot. Similarly, the cable retention tab 132 is integrated on one end with the second divider 114 and covers a portion of the cable slot 120 at the open end 124 of the cable slot. The cable retention tabs 134 are integrated with the center divider 116 and cover a portion of both the cable slots 118, 120 at the respective open ends 122, 124 of the cable slots. Together, the cable retention tabs form a barrier at the open ends 122, 124 of the respective cable slots 118, 120 effective to prevent installed cables from falling out of the cable slots. The cable retention tabs 130, 132, 134 are flexibly integrated (or flexibly attached, flexibly connected) with the dividers, allowing the cable retention tabs to pivot at the point of flexible attachment or integration with a divider, and provide that cables can be installed and removed from the cable slots.

At 708, retention locks are engaged to close open ends of the cable slots, where a retention lock is integrated with a divider and designed to engage a detent in another of the dividers to close the open end of a respective cable slot. As an alternative to the cable retention tabs described with reference to the example cable stacker 100, the example cable stacker 500 includes retention locks that close the open ends of the cable slots 520, 522, and secure the cables that are installed into the cable slots. For example, the retention lock 530 is integrated on one end with the first divider 514 and is designed to engage the detent 532 in the center divider 518 to close the open end of the cable slot 520 that is formed between the first divider 514 and the center divider 518. The retention lock 530 is flexibly integrated (or flexibly attached, flexibly connected) with the first divider 514, allowing the retention lock 530 to pivot at the point of flexible attachment or integration with the first divider, and provides that cables can be installed and removed from the cable slot 520. Similarly, the retention lock 534 is integrated on one end with the second divider 516 and is designed to engage the detent 536 in the center divider 518 to close the open end of the cable slot 522 that is formed between the second divider 516 and the center divider 518. The retention lock 534 is flexibly integrated (or flexibly attached, flexibly connected) with the second divider 516, allowing the retention lock 534 to pivot at the point of flexible attachment or integration with the second divider, and provides that cables can be installed and removed from the cable slot 522.

Although implementations of a cable stacker have been described in language specific to features and/or methods, the appended claims are not necessarily limited to the specific features or methods described. Rather, the specific features and methods are disclosed as example implementations of a cable stacker, and other equivalent features and methods are intended to be within the scope of the appended claims. Further, various different examples are described and it is to be appreciated that each described example of a cable stacker can be implemented independently or in connection with one or more other described examples of the cable stacker. Additional aspects of the techniques, features, and/or methods discussed herein relate to one or more of the following:

A cable stacker, comprising: a base for placement against a framing stud; and dividers that extend perpendicular from the base, the dividers forming cable slots between the dividers, the cable slots configured to accommodate one or more cables that are guided in place between the dividers through open ends of the cable slots.

Alternatively or in addition to the above described cable stacker, any one or combination of: the dividers include a first divider, a second divider, and a center divider; a first cable slot is formed between the first divider and the center divider; and a second cable slot is formed between the second divider and the center divider. The cable stacker comprises cable retention tabs integrated with the dividers, the cable retention tabs configured to cover at least a portion of the open ends of the cable slots and retain the one or more cables in the cable slots. The cable stacker comprises retention locks that close the open ends of the cable slots, each of the retention locks being integrated with a divider and configured to engage a detent in another of the dividers to close the open end of a respective one of the cable slots. A first retention lock is flexibly connected to the first divider and configured to engage a first detent in the center divider to close the first cable slot that is formed between the first divider and the center divider; and a second retention lock is flexibly connected to the second divider and configured to engage a second detent in the center divider to close the second cable slot that is formed between the second divider and the center divider. The base, the dividers, and the retention locks form a rigid structural box around the one or more cables that are guided in place between the dividers. The cable stacker comprises angle supports integrated with the base and the dividers effective to strengthen the rigid structural box that is formed by the base, the dividers, and the retention locks. The cable stacker comprises at least one integrated nail guide to facilitate attachment of the cable stacker to the framing stud with at least one nail, the integrated nail guide configured to retain the nail in an installation position. The cable stacker comprises at least one integrated staple guide to facilitate attachment of the cable stacker to the framing stud with at least one staple, the integrated staple guide configured to retain the staple in an installation position. The cable stacker comprises at least one integrated screw guide to facilitate attachment of the cable stacker to the framing stud with at least one screw, the integrated screw guide configured to retain the screw in an installation position. The cable stacker comprises cable separators that extend from the dividers into the cable slots to separate the cables that are guided in place between the dividers. Each of the cable separators extend perpendicular from one of the dividers into one of the cable slots and is approximately horizontal to the base of the cable stacker. Each of the cable separators that extend from one of the dividers into one of the cable slots is removable to accommodate larger diameter cables being installed in the cable slots.

A method implemented with a cable stacker, the method comprising: retaining a fastener in an integrated guide of the cable stacker for placement of a base of the cable stacker against a framing stud and attachment of the cable stacker to the framing stud; and receiving one or more cables that are guided in cable slots between dividers that extend perpendicular from the base and form the cable slots.

Alternatively or in addition to the above described method, any one or combination of: separating two or more of the cables that are guided into one of the cable slots between the dividers with cable separators that extend from the dividers into the cable slot. The method further comprising retaining the one or more cables that are guided into the cable slots between the dividers with cable retention tabs that are integrated with the dividers, the cable retention tabs configured to cover at least a portion of open ends of the cable slots and retain the one or more cables in the cable slots. The method further comprising engaging retention locks that close open ends of the cable slots, each of the retention locks being integrated with a divider and configured to engage a detent in another of the dividers to close one of the open ends of a respective cable slot. The fastener is a nail retained in an installation position with an integrated nail guide of the cable stacker to facilitate the attachment of the cable stacker to the framing stud with the nail. The fastener is at least one staple retained in an installation position with an integrated staple guide of the cable stacker to facilitate the attachment of the cable stacker to the framing stud with the at least one staple. The fastener is at least one screw retained in an installation position with an integrated screw guide of the cable stacker to facilitate the attachment of the cable stacker to the framing stud with the at least one screw.

1. A cable stacker, comprising:
a base for placement against a framing stud; and
dividers that extend perpendicular from the base, the dividers forming cable slots between the dividers, the cable slots configured to accommodate one or more cables that are guided in place between the dividers through open ends of the cable slots.

2. The cable stacker as recited in claim 1, wherein:
the dividers include a first divider, a second divider, and a center divider;
a first cable slot is formed between the first divider and the center divider; and
a second cable slot is formed between the second divider and the center divider.

3. The cable stacker as recited in claim 2, further comprising:
cable retention tabs integrated with the dividers, the cable retention tabs configured to cover at least a portion of the open ends of the cable slots and retain the one or more cables in the cable slots.

4. The cable stacker as recited in claim 2, further comprising:
retention locks that close the open ends of the cable slots, each of the retention locks being integrated with a divider and configured to engage a detent in another of the dividers to close the open end of a respective one of the cable slots.

5. The cable stacker as recited in claim 4, wherein:
a first retention lock is flexibly connected to the first divider and configured to engage a first detent in the center divider to close the first cable slot that is formed between the first divider and the center divider; and
a second retention lock is flexibly connected to the second divider and configured to engage a second detent in the center divider to close the second cable slot that is formed between the second divider and the center divider.

6. The cable stacker as recited in claim 4, wherein the base, the dividers, and the retention locks form a rigid structural box around the one or more cables that are guided in place between the dividers.

7. The cable stacker as recited in claim 6, further comprising:
angle supports integrated with the base and the dividers effective to strengthen the rigid structural box that is formed by the base, the dividers, and the retention locks.

8. The cable stacker as recited in claim 1, further comprising:
at least one integrated nail guide to facilitate attachment of the cable stacker to the framing stud with at least one nail, the integrated nail guide configured to retain the nail in an installation position.

9. The cable stacker as recited in claim 1, further comprising:
at least one integrated staple guide to facilitate attachment of the cable stacker to the framing stud with at least one staple, the integrated staple guide configured to retain the staple in an installation position.

10. The cable stacker as recited in claim 1, further comprising:
at least one integrated screw guide to facilitate attachment of the cable stacker to the framing stud with at least one screw, the integrated screw guide configured to retain the screw in an installation position.

11. The cable stacker as recited in claim 1, further comprising:
cable separators that extend from the dividers into the cable slots to separate the cables that are guided in place between the dividers.

12. The cable stacker as recited in claim 11, wherein each of the cable separators extend perpendicular from one of the dividers into one of the cable slots and is approximately horizontal to the base of the cable stacker.

13. The cable stacker as recited in claim 11, wherein each of the cable separators that extend from one of the dividers into one of the cable slots is removable to accommodate larger diameter cables being installed in the cable slots.

14. A method for a cable stacker, the method comprising:
retaining a fastener in an integrated guide of the cable stacker for placement of a base of the cable stacker against a framing stud and attachment of the cable stacker to the framing stud; and
receiving one or more cables that are guided in cable slots between dividers that extend perpendicular from the base and form the cable slots.

15. The method as recited in claim 14, further comprising:
separating two or more of the cables that are guided into one of the cable slots between the dividers with cable separators that extend from the dividers into the cable slot.

16. The method as recited in claim 14, further comprising:
retaining the one or more cables that are guided into the cable slots between the dividers with cable retention tabs that are integrated with the dividers, the cable retention tabs configured to cover at least a portion of open ends of the cable slots and retain the one or more cables in the cable slots.

17. The method as recited in claim 14, further comprising:
engaging retention locks that close open ends of the cable slots, each of the retention locks being integrated with a divider and configured to engage a detent in another of the dividers to close one of the open ends of a respective cable slot.

18. The method as recited in claim 14, wherein the fastener is a nail retained in an installation position with an integrated nail guide of the cable stacker to facilitate the attachment of the cable stacker to the framing stud with the nail.

19. The method as recited in claim 14, wherein the fastener is at least one staple retained in an installation position with an integrated staple guide of the cable stacker to facilitate the attachment of the cable stacker to the framing stud with the at least one staple.

20. The method as recited in claim 14, wherein the fastener is at least one screw retained in an installation position with an integrated screw guide of the cable stacker to facilitate the attachment of the cable stacker to the framing stud with the at least one screw.
